(19) United States
(12) Patent Application Publication
(10) Pub. No.: US 2026/0318115 A1
(43) Pub. Date: Oct. 15, 2026

(54) ELECTRONIC SYSTEM

(71) Applicant: KRYPTON ARC PTY LTD, Doreen, Victoria (AU)

(72) Inventor: Seyed Mohammad Ali SADAT AKHAVI, Doreen, Victoria (AU)

(21) Appl. No.: 19/156,951

(22) PCT Filed: Feb. 16, 2024
(86) PCT No.: PCT/AU2024/050106

§ 371 Date: Aug. 15, 2025

(30) Foreign Application Priority Data
Feb. 17, 2023 (AU) 2023900406

(51) Int. Cl. E05B 47/00; E05B 67/22

(52) U.S. Cl. CPC E05B 47/0012; E05B 67/22; E05B 2047/0017; E05B 2047/0057

(57) ABSTRACT

An electronic system having a body that comprises a control system and an electronic power receiver. The electronic power receiver is activated to operate the control system by a wireless transmission of electrical power from an external power source.

### TECHNICAL FIELD

This disclosure relates generally to an electronic system that derives electrical power from an external source, including an electronic locking system.

### BACKGROUND

A lock is a mechanical or electronic fastening device that is used to secure or restrict access to assets, properties or resources. The locks are able to be opened using a physical object such as a key, keycard, fingerprint, RFID card, security token or coin, or by supplying secret information such as a number or letter permutation or password; however, securely storing and managing the physical keys and secret information can be challenging and expensive.

For example, whilst a master key that is able to unlock a large number of locks can be helpful in improving the efficiency of management of security, the risk of security exposure is significantly greater in the event that a master key is lost. In a further example, keyless smart padlocks are available that are controlled by passcodes or connection with smart devices; however these smart devices are typically battery powered, limiting their operational life and incurring significant ongoing maintenance costs. Alternatively, the smart padlocks can be connected to a mains power source reducing mobility and flexibility of the application for which the lock can be used, and incurring larger up front installation costs.

There remains a need for an improved locking system that provides increased flexibility of application to users. There also remains a need for a cost-effective locking system that can more efficiently manage the risk of security exposure.

It is desired to address or ameliorate one or more disadvantages or limitations associated with the prior art, or to at least provide a useful alternative.

### SUMMARY OF THE DISCLOSURE

In a first aspect, embodiments are disclosed of an electronic system. The electronic system has a body that comprises a control system and an electronic power receiver. The electronic power receiver is activated to operate the control system by a wireless transmission of electrical power from an external power source.

In some embodiments, the body may comprise a first surface and a second surface, and opposing sidewalls that extend therebetween, the first surface comprising one or more apertures therethrough. In some embodiments, the one or more apertures may extend through the body and the second surface on an opposing side of the body. In some embodiments, the one or more apertures through the second surface are aligned with the one or more apertures through the first surface. In some embodiments, when the body comprises a plurality of the one or more apertures that extend through the body, the plurality of apertures may extend parallel to another and may be spaced from one another across the first and second surfaces, respectively.

In some embodiments, the electronic system may further comprise a shackle, the body being adapted to receive at least a portion of one or more arms of the shackle therein through the one or more apertures of the first surface. In some embodiments, the one or more arms of the shackle may extend through, and protrude beyond, the body. In some embodiments, the shackle may have a substantially U-shape. In some embodiments, the one or more arms of the shackle may be substantially equal in length.

In some embodiments, the electronic system may further comprise a locking mechanism that is at least partially contained within the body. The locking mechanism may be configurable by the control system between a locked configuration, in which the locking mechanism engages with the portion of the one or more arms of the shackle received within the body, in use, so as to prevent relative movement of the shackle relative to the body, and an unlocked configuration in which the shackle is allowed to move relative to the body. In some embodiments, in the unlocked configuration the one or more arms of the shackle may be moved a distance relative to the body and/or may be removed from the body. In some embodiments, in the unlocked configuration the locking mechanism may allow the shackle to move relative to the body and prevent removal of the entirety of the shackle outside of the body.

In some embodiments, the locking mechanism may comprise one or more locking bars, each of the one or more locking bars being arranged to project towards, and engage with, a groove provided in an adjacent one of the arms of the shackle when in the locked configuration, and each of the one or more locking bars being arranged to retract away from the adjacent one of the arms of the shackle by a movement of the shackle relative to the one or more locking bars when in the unlocked configuration. In some embodiments, in the unlocked configuration, the one or more locking bars may be configured to resiliently retract.

In some embodiments, the locking mechanism may further comprises a rotatable drum that is controlled to rotate by the control system. The drum has a locking wall that, when in the locked configuration, is controlled by the control system to be rotated so as to locate adjacent to a first end of the one or more locking bars so as to prevent a retraction of the opposing second end of the one or more locking bars from the groove. The drum has a hole provided in a portion thereof whereby, when in the unlocked configuration, the drum is controlled by the control system to be rotated such that the hole locates adjacent to, and is adapted to receive therein, the first end of the one or more locking bars therein so as to allow the retraction of the opposing second end of the one or more locking bars from the groove.

In some embodiments, the body may comprise a first shell having the first surface and a portion of the side walls, and a second shell having the second surface and a portion of the side walls. In some embodiments, a cross-section of the side walls of the second shell may be smaller than a cross-section of the side walls of the first shell, whereby the side walls of the second shell can be slidably received, at least in part, within the side walls of the first shell. In some embodiments, the first shell and/or second shell comprises non-magnetic material. In some embodiments, the electronic power receiver may be retained in a cavity formed adjacent one or more of the side walls of the body.

In some embodiments, the wireless transmission of electrical power may include near-field inductive coupling of magnetic fields. In some embodiments, the electronic power receiver may utilise NFC and/or Qi charging standards. In some embodiments, the electronic power receiver may not store electrical power and/or may not receive electrical power from a battery and/or a surge capacitor except via the wireless transmission.

In some embodiments, the control system, when activated to operate, may communicate with and/or be controlled by the external power source to implement one or more configuration changes and/or actions. In some embodiments, the control system, when activated to operate, may communicate with and/or be controlled by a remotely located server.

In some embodiments, the system may further comprise one or more brackets adapted for mounting the electronic system to a surface. In some embodiments, the system may further comprise a cover that reduces ingress of water and/or dust and/or contamination into the system.

In some embodiments, the electronic system may further comprise an extension module, the extension module being adapted to be removably coupled to, or secured in adjacency to, the body. In some embodiments, the extension module may have a cross-sectional shape that substantially conforms to a cross-sectional shape of the body. In some embodiments, the extension module may comprise a first and a second surface, and opposing sidewalls that extend therebetween, the first surface comprising one or more apertures that extend through the extension module and the second surface on an opposing side of the extension module, the one or more apertures being arranged to align with, and extend collinearly with an axis through the centre of, the one or more apertures through the first surface of the body. In some embodiments, the one or more apertures through the extension module may be adapted to receive the one or more arms of the shackle therethrough.

In some embodiments, a length of the arms of the shackle may correspond to a cumulative length of the body and one or more of the extension modules. In some embodiments, the relative position of the extension module along the one or more arms of the shackle may be fixed by a fixed engagement of the body with the shackle.

In some embodiments, the extension module may derive electrical power from the body and/or provides electrical power to the body when the electronic power receiver has been activated in use. In some embodiments, the control system, when activated to operate, may communicate with and/or control and/or be controlled by the extension module to implement one or more configuration changes and/or actions. In some embodiments, the extension module may be configured to communicate with and/or control and/or be controlled by additional extension modules to implement one or more configuration changes and/or actions. In some embodiments, the extension module may be configured to include one or more of a speaker, a microphone, a cellular and/or wireless connection module, a keypad or alternative user interface module, a GPS and/or location tracking module, an alarm module, a module capable of providing light, a line-of-sight communication module, a camera module, a battery module, a solar panel module, an AC powered module, a doorbell module, a key vault module, and/or a safe vault module.

In some embodiments, the external power source may include a smart device.

In some embodiments, the electronic system may be, or may be integrated with, a bicycle lock, a security door, a gate, a safe, a storage unit, a window lock, a suitcase lock, a motor vehicle lock, a cabinet lock, a mono-block lock, a container lock, a musical instrument case lock, and/or a steering wheel lock.

In some embodiments, the electronic power receiver may be activated to operate the control system by receiving at least 10 mW of electrical power. In some embodiments, the electronic power receiver may be activated to operate the control system by receiving at least 0.5 W of electrical power. In some embodiments, the electronic power receiver may be activated to operate the control system by receiving at least 3.5 W of electrical power.

Other aspects, features, and/or advantages will become apparent from the following detailed description when taken in conjunction with the accompanying drawings, which are a part of this disclosure and which may illustrate, by way of example, principles of inventions disclosed.

### DESCRIPTION OF THE FIGURES

The accompanying drawings facilitate an understanding of the various embodiments. The invention will now be described, by way of non-limiting example only, with reference to the accompanying drawings, in which:

FIGS. 1a to 1f are a projection view from above, projection view from below, front view, left side view, rear view and right side view, respectively, of a first embodiment of an electronic system.

FIG. 2 is a front section view through A-A of FIG. 1d of the first embodiment of an electronic system.

FIGS. 3a and 3b are a front and angled-side view, respectively of a first embodiment of a locking mechanism.

FIG. 3c is a front view of the locking mechanism of FIGS. 3a and 3b and a first embodiment of a shackle.

FIGS. 4a to 4c are an exploded projection, front and side view, respectively, of the first embodiment of the electronic system.

FIG. 5 is a projection view of the first embodiment of the electronic system without an upper sleeve.

FIGS. 6a and 6b are a projection view and plan view, respectively, of a first embodiment of the upper sleeve.

FIGS. 7a to 7e are projection views of a first, second, third, fourth and fifth embodiment of a lower sleeve (also referred to as a “lid”), respectively.

FIGS. 8a and 8b are a projection view from below and front view, respectively, of a second embodiment of the electronic system.

FIGS. 9a and 9b are a side view and a front section view through C-C of FIG. 9a, respectively, of the second embodiment of the electronic system.

FIGS. 10a and 10b are a front view and a side view, respectively, of a third embodiment of the electronic system.

FIGS. 11a and 11b are an exploded side view and a front section view through D-D of FIG. 11a, respectively, of the third embodiment of the electronic system.

FIGS. 12a, 12b and 12c are an exploded projection view, side view and a front section view, respectively, of the modules of the third embodiment of the electronic system.

FIGS. 13a, 13b and 13c are a front view, side view and a front section view through E-E of FIG. 13b, respectively, of a fourth embodiment of the electronic system.

FIGS. 14a and 14b are a perspective front and perspective rear view, respectively, of a fifth embodiment of the electronic system.

FIG. 14c is a perspective front view of the fifth embodiment of the electronic system, with the plastic outer casing panel removed.

FIG. 14d is a section front view of the fifth embodiment of the electronic system cut along section F-F.

FIG. 15a is a perspective front view of a sixth embodiment of the electronic system.

FIG. 15b is a section front view of the sixth embodiment of the electronic system cut along section G-G.

FIGS. 16a and 16b are a perspective rear and perspective front view, respectively, of a seventh embodiment of the electronic system.

FIG. 16c is a section front view of the seventh embodiment of the electronic system cut along section H-H.

FIG. 17a is a perspective front view of an eighth embodiment of the electronic system.

FIG. 17b is a perspective side view of the eighth embodiment of the electronic system, with the safe door in an open position.

### DETAILED DESCRIPTION

Referring to the Figures, the present invention relates to embodiments of an electronic system 100 that is powered by a wireless transmission of electrical power from an external transmitter in order to activate and operate one or more functions of the electronic system 100. For example, the electronic system 100 can be arranged as a smart lock system, where the base module 50 includes a locking mechanism 10 that is controlled by a control system 30 that is activated when powered by an input of electrical power from an external power source (which may, for example, include a smart phone) that is provided separately from the electronic system 100 and is separable from, and may locate externally from, the electronic system 100. The electronic system 100 is configured to receive the input of electrical power via a wireless power receiver 20. The power receiver 20 does not store the electrical power received from the wireless transmission. For example, the wireless power receiver 20 may be configured to utilise the Qi or NFC charging standards although, as would be appreciated by a person skilled in the art, a variety of near field wireless technologies may similarly be used for this function. The Near-Field communication (NFC) charging standards include a set of communication protocols that enables communication between two electronic devices over a distance of substantially 4 cm or less. The Qi charging standards define wireless power transfer using inductive charging over distances of up to substantially 4 cm. The electronic system 100 is battery-less (or “batteryless”) and/or does not receive electrical power from a battery and/or a surge capacitor in the electronic system 100 itself; in other words, the electronic system 100 has insufficient electrical power storage to power one or more of its functions, e.g., by powering the locking mechanism 10 and/or the control system 30, and thus the electronic system 100 requires the electrical power received via the wireless transmission to power these functions. The system 100 may provide a convenient and secure way to lock and unlock the base module 50 of the padlock system and/or control extension modules 60 attached to the base module 50 without the need for a physical key or combination, making it a useful tool for a wide range of electronic applications that operate a lock system, such as a bicycle lock, a security door or gate, a safe, a storage unit, window lock, suitcase lock, motor vehicle lock, and more. Where like reference numerals are used in the following description, the features are considered to be the same unless specified as being otherwise.

For example, an external power source (i.e. wireless transceiver) can be used to wirelessly transmit electrical energy to the electronic system 100 using the Qi charging standard. The Qi charging standard allows for a wireless transfer rate of at least substantially 10 mW, however preferably substantially at least 0.5 W, or even more preferably substantially 3.5 W of energy may be continuously transferred to the electronic system 100 whilst the external power source remains within the required distance proximal to the wireless power receiver 20. For example, in some variations using Qi Baseline Power Profile (BPP), up to substantially 5 W of energy may be continuously transferred to the electronic system 100 whilst the external power source remains within the required distance proximal to the wireless power receiver 20. In a further example, in some variations using Qi Extended Power Profile (EPP), up to substantially 15 W of energy may be continuously transferred to the electronic system 100 whilst the external power source remains within the required distance proximal to the wireless power receiver 20.

In use, upon removal of the external power source, by a movement away from the wireless power receiver 20 (e.g. greater than distances of up to substantially 4 cm) the electronic system 100 ceases the powered operation and functionality substantially simultaneously and immediately, as the electronic system 100 does not store the electrical energy transferred wirelessly thereto by the external power source. Qi charging standard may advantageously enable the transfer of a greater magnitude of electrical power to the electronic system 20 for immediate use, without storage in a battery, capacitor, or power cell or similar, when compared with NFC charging standards. This may enable a smooth continuous powered operation of the electronic system 100 without the need for storage of the wirelessly transferred electrical energy. In addition, the magnitude of electrical power transferred may also be sufficient for powering additional electronic modules or systems that are coupled with the primary electronic system 100. As would be appreciated by one skilled in the art, whilst Qi charging standard does not support data communication, an electronic system 100 using Qi charging standard may be used in conjunction with a variety of communication standards including, but not limited to, NFC, Bluetooth, IRDA, LoraWAN etc.

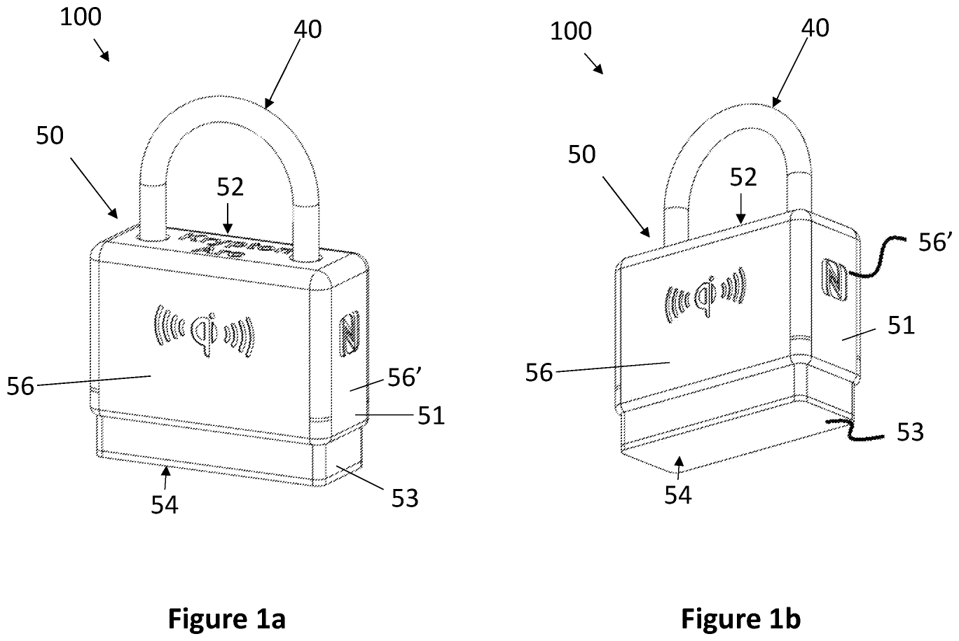

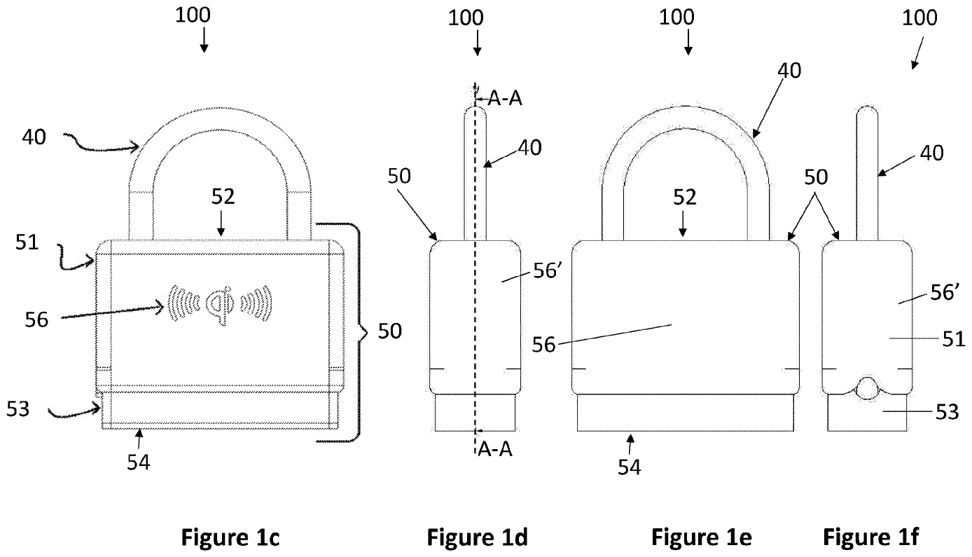

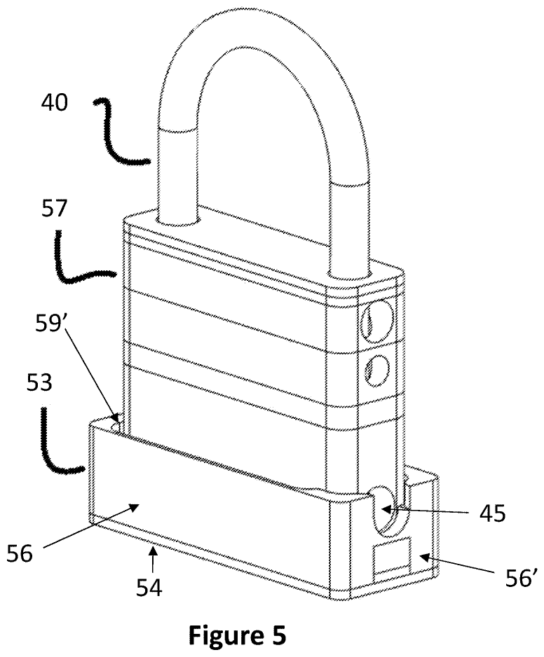

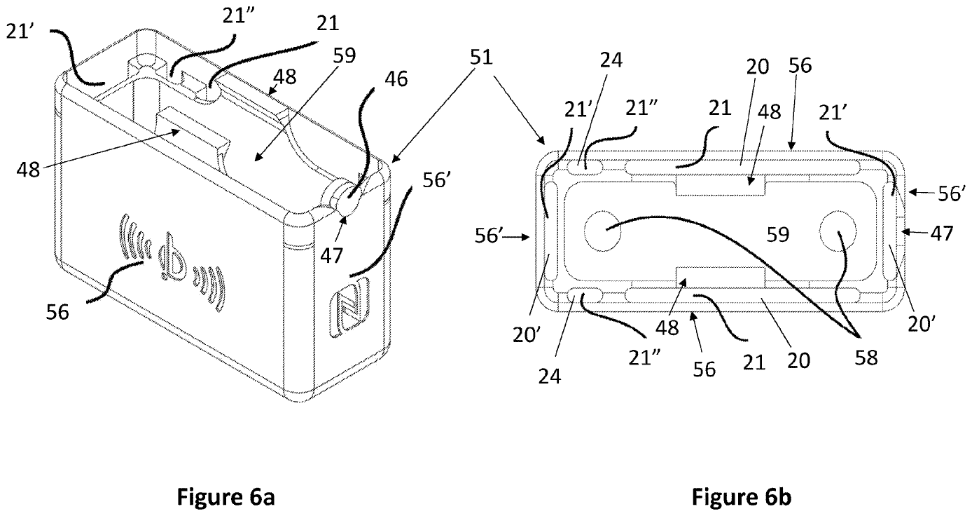

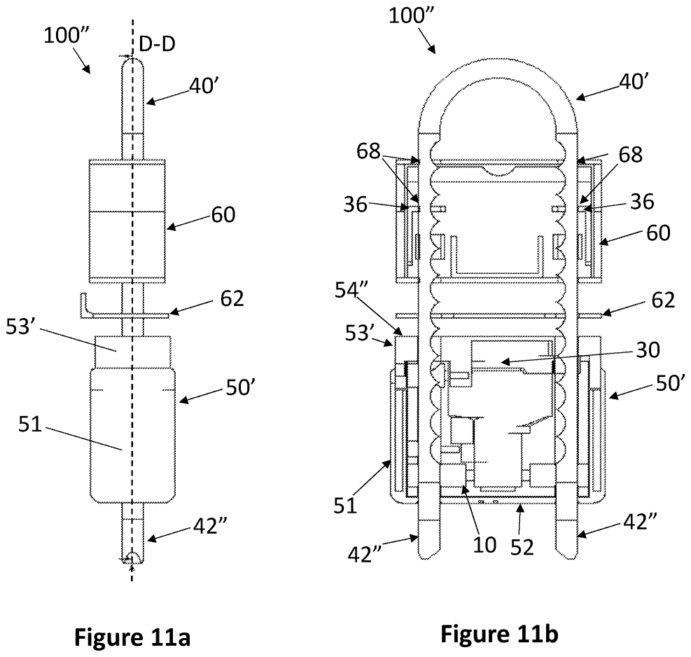

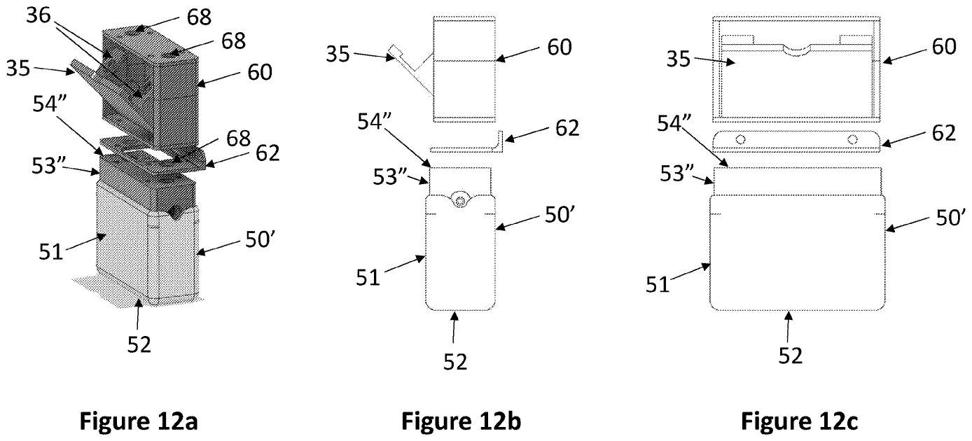

Referring to FIGS. 1 to 13, a first embodiment of an electronic system 100 is shown, as applied to a modular smart padlock system. The base module 50 of the electronic system 100 has a tamper proof shell that defines a body within which the control system 30 and wireless power receiver 20 are contained. The body is formed to have opposing rectangularly-shaped planar upper 52 and lower surfaces 54 that are arranged to extend substantially parallel to one another, with two pairs of opposing sidewalls 56,56′ formed to extend between the upper 52 and lower surfaces 54. In a variation, as would be appreciated by a person skilled in the art, the body of the base module can be formed to define a variety of prismatic or other three-dimensional geometrical shapes.

The upper surface 52 comprises one or more apertures 58, and preferably a pair of apertures 58, through which at least one of two arms 42,42′ of a substantially U-shaped shackle 40 is able to be received in order to enter the body of the base module 50. The apertures 58 are adapted to have a diameter that corresponds to the diameter of a respective one of the arms 42,42′ of the shackle 40, with the spacing of the apertures 58 from each other across the upper surface 52 also corresponding to a spacing of distal ends of the arms 42,42′ from each other. In variations, not shown, the shackle can be formed as a chain of linked metallic rings or formed as a door latch assembly, with at least a portion of the shackle being insertable and lockable by the locking mechanism within the base module.

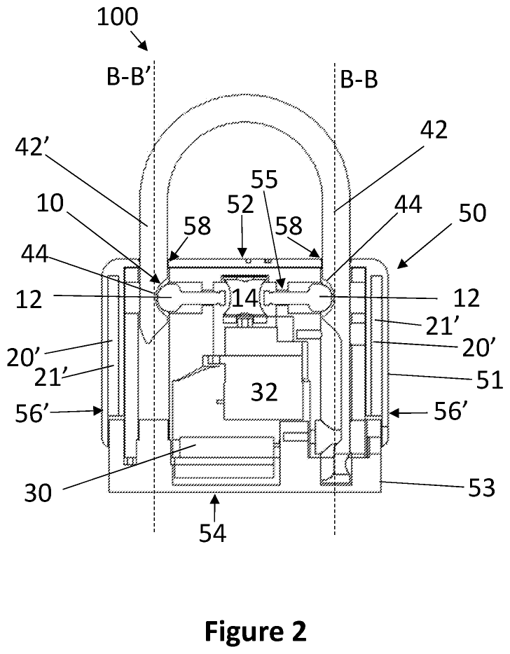

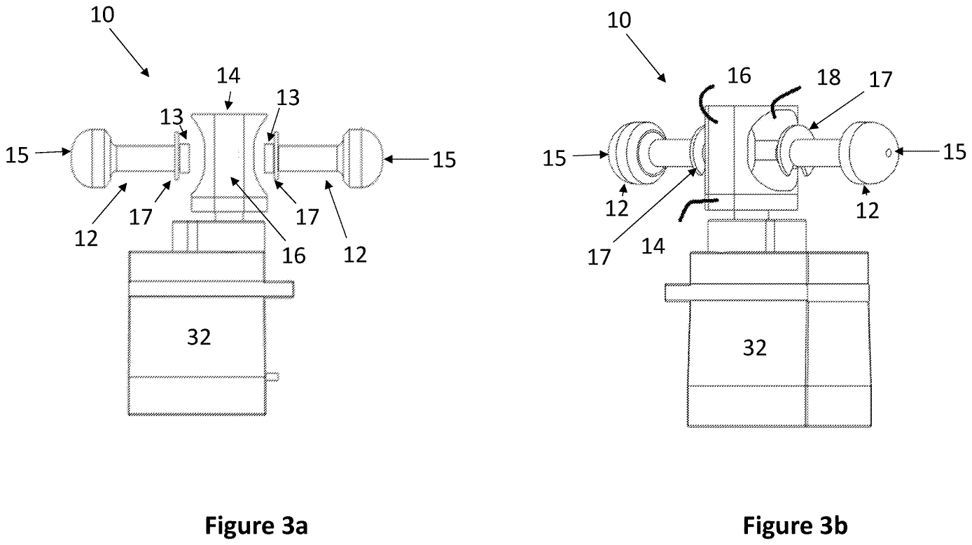

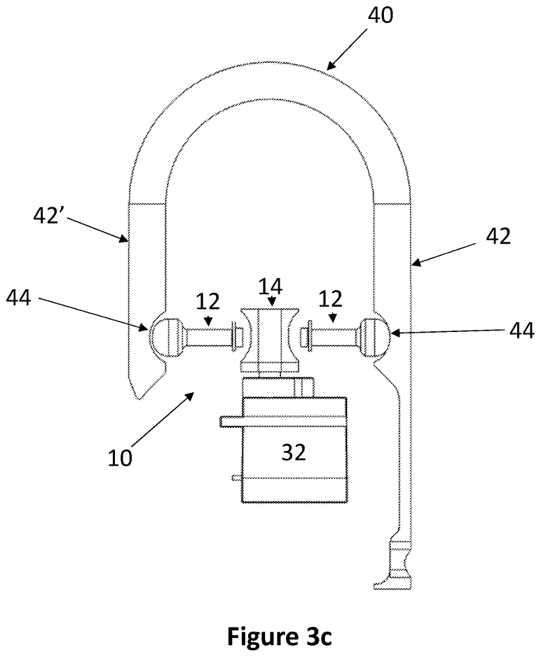

Referring to FIGS. 2 and 3, the locking mechanism 10 is at least partially contained within the base module 50, and preferably entirely contained within the tamper proof shell of the base module 50. The locking mechanism 10 comprises one or more locking bars 12, preferably a locking bar 12 corresponding to each arm 42 of the shackle 40, with each of the locking bars 12 supported to extend perpendicularly relative to a longitudinal axis B-B of the adjacent arms 42,42′ of the shackle 40. The first arm 42 of the shackle 40 is longer in length than the second arm 42′, and the shackle 40 is adapted to pivot about the first arm 42 when the locking mechanism 10 allows the shorter second arm 42′ to be lifted out of the body of the base module 50 via the aperture 58 in the upper surface 52. An outer distal end 15 of each of the locking bars 12 defines a convex curved surface that is adapted to mate with a correspondingly shaped concave groove 44 provided within a side of each arm 42,42′ of the shackle 40, in the side of the arm 42,42′ that faces inwardly towards the adjacent one of the locking bars 12. Inner distal ends 13 of the locking bars 12 are adapted to locate adjacent a rotatable drum 14 that is positioned between the locking bars 12. The drum 14 comprises holes 18 (e.g., a singular hole 18 that extends diametrically through and between opposing sides of the drum 14, or two individual holes 18 located at diametrically opposing sides of the drum 14), and two locking walls 16 that are located at opposing sides of the drum 14, with the holes 18 and locking walls 16 positioned to locate approximately 90 degrees around the circumference of the drum 14 from one another. As would be appreciated by a person skilled in the art, variations of the drum can comprise one or a plurality of holes and/or locking walls positioned at a variety of angles relative to one another around the circumference of the drum 14. As the drum 14 is rotated, the inner distal ends 13 of the locking bars 12 align with either a hole 18, which allows for the inner distal ends 13 to be resiliently moved therein, or a locking wall 16 of the drum 14, which prevents longitudinal sliding movement of the locking bars 12. The configuration of the drum 14 can be controlled by the control system 30 by operating a motor 32 (e.g. a servo motor) in order to rotate the drum 14 such that each of the inner distal ends 13 aligns with a hole 18 or a locking wall 16, as desired, to respectively release or secure the locking bars 12. Thus, depending on the configuration of the drum 14, the locking bars 12 can be locked in an extended configuration (by the walls 16) or slidingly moved into a retracted configuration (into the holes 18), with a spring being arranged to resiliently returning the locking bars 12 to the extended configuration. The spring, not shown, can be arranged on shafts of the locking bars 12 between an inner (proximal) side of the bulbous outer distal end 15 and an outwardly (distally) facing surface of a locking mechanism support wall 55 within the body of the base module 50. The locking bars 12 are supported to pass through an aperture in the locking mechanism support wall 55, with the inner distal ends 13 of the locking bars 12 being prevented from being removed through the aperture by a clip 17, e.g., a circlip or similar, that can be secured adjacent the inner distal ends 13 of the locking bars 12 on the inward side of the locking mechanism support wall 55. The clip 17 has a diameter that is larger than the aperture through the locking mechanism support wall 55, thereby preventing removal of the locking bars 12 through the aperture.

When the drum 14 is rotated by the control system 30 such that the respective inner ends 13 of the locking bars 12 align with the locking walls 16 of the drum 14, the locking walls 16 prevents inward movement of the adjacent locking bars 12, with the or each inner end 13 abutting the or each corresponding locking wall 16. With the locking bars 12 maintained in the extended configuration by the locking walls 16 of the drum 14, the outer distal ends 15 of the locking bars 12 are adapted to project into, and engage with, the correspondingly shaped groove 44 provided on the side of each arm 42,42′ that faces the adjacent one of the locking bars 12. When the outer distal end 15 of the or each locking bar 12 locates in its corresponding groove 44, the locking bar 12 overlaps with the cross-sectional diameter of the respective arm 42,42′, thereby substantially preventing movement of the shackle 40 relative to the base module 50, with the arm 42,42′ of the shackle 40 substantially unable to move longitudinally along its respective central axis B-B, B-B′, thereby defining a locked configuration of the locking mechanism 10.

When the drum 14 is rotated by the control system 30 such that the inner end 13 of each of the locking bars 12 aligns with a respective one of the holes 18 of the drum 14, the holes 18 have sufficient width and depth so as to receive at least a portion of the locking bars 12 therein. The depth of the holes 18 is such that, when the locking bars 12 are (resiliently) depressed, the locking bars 12 are able to slide laterally towards the drum 14 to an extent, defining a retracted configuration, whereby the outer distal end 15 of the or each locking bar 12 does not overlap substantially with the cross-sectional diameter of its respective arm 42,42′, thereby allowing the arms 42,42′ of the shackle 40 to move relative to the locking bars 12, with each of the arms 42,42′ moving longitudinally along its respective central axis B-B, B-B′. The rotation of the drum 14 such that the locking bars 12 align with the holes 18 is therefore able to define an unlocked configuration of the locking mechanism 10. In use, movement of the arms 42,42′ longitudinally along their respective central axes B-B, B-B′ causes the relative position of the or each concave curved groove 44 to shift with respect to the outer distal end 15 of the or each adjacent locking bar 12. In order to accommodate for the increased width of an adjacent portion of the arm 42,42′ as the arm 42,42′ moves along their respective central axes B-B, B-B′ relative to the locking bar 12, the concave shape of the groove 44 and/or the convex shape of the end 15 force the outer distal end 15 of each of the locking bars 12 to depress, and move inwardly, with the respective inner ends 13 of each of the locking bars 12 able to slide within the adjacent aligned holes 18. When the inwardly acting force of the increased width of the adjacent portion of the arm 42,42′ is removed, for example when the outer distal end 15 aligns with a further groove 44, the locking bars 12 are able to resiliently return to their extended configuration. The arms 42,42′ of the shackle 40 are thus able to move relative to the locking bars 12 and base module 50, with each of the arms 42,42′ moving longitudinally along its respective central axis B-B, B-B′, in, out or through the apertures 58 when the locking mechanism 10 is in the unlocked configuration.

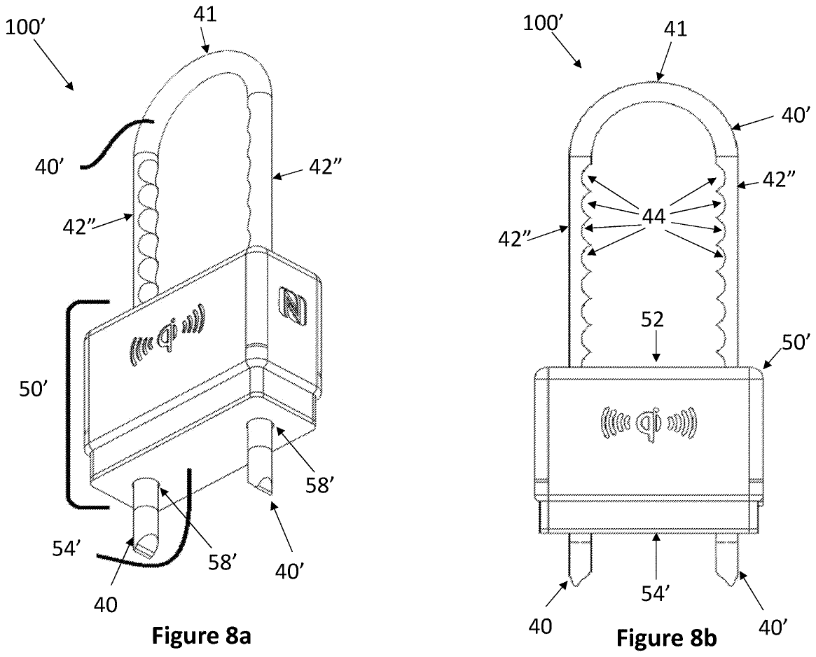

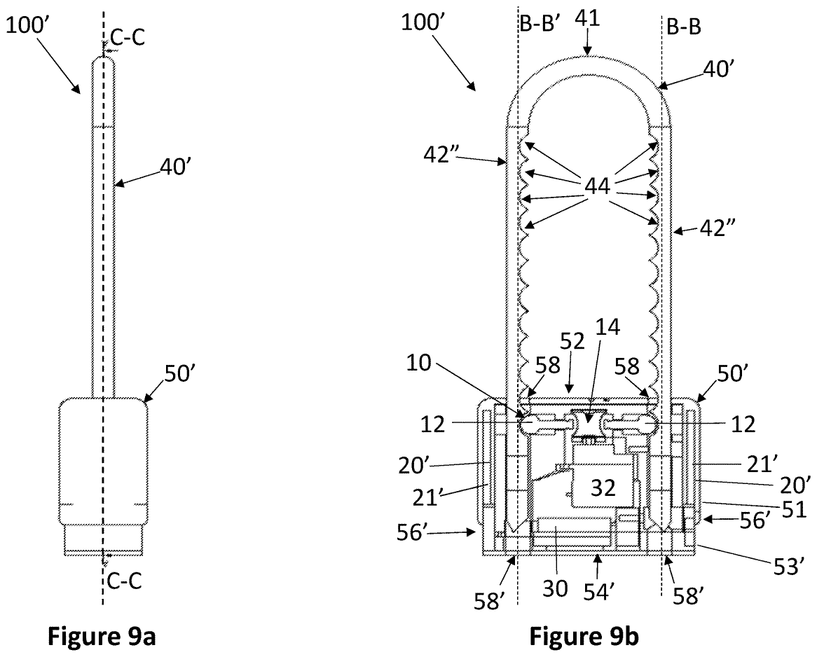

The control system 30 can be programmed to maintain the locking mechanism 10 in the locked or unlocked configuration for a pre-determined period and/or indefinitely. In some variations, the control system 30 can control the locking mechanism 10 to define a loose configuration for a pre-determined period or indefinitely. The loose configuration defines a sub-configuration of the unlocked configuration, wherein the locking mechanism 10 allows the shackle 40 to move relative to the base module 50 whilst simultaneously preventing the removal of the entirety of each of the shackle arms 42,42′ outside of the base module 50. For example, referring to FIGS. 8 and 9, the electronic system 100′ can comprise a U-shaped shackle 40′ having one or a pair of elongate arms 42″ of substantially equal length, with the or each of the arms 42 comprising a plurality of grooves 44 along the inwardly facing side of each arm 42″ that faces inwardly towards the opposing arm 42″of the shackle 40′. The grooves 44 can be arranged adjacent to one another along the length of an intermediate portion the arms 42″ or at spaced intervals from one another. The control system 30 can be programmed to allow for the distance between the top 41 of the U-shaped curve of the shackle 40′ to be adjusted relative to the upper surface 52 of the base module 50′, whilst restricting against the removal of the entirety of the arms 42″ of the shackle 40′ outside of the base module 50′. In some further variations, not shown, the drum can comprise a wall intermediate (“loose-configuration wall”) the hole and locking wall. The loose-configuration wall is adapted to allow the locking mechanism to maintain the loose configuration, whilst preventing the removal of the entirety of the arms of the shackle outside of the base module.

In some variations, the locking bar 12 can be configured to resiliently return to the extended configuration (by the control of the motor 32), for example after a pre-determined period of time, or when the control system 30 detects that the wireless power receiver 20 has stopped receiving electrical power. In some variations, the locking bar 12 can configured to resiliently return to the extended configuration (by the control of the motor 32) if, for example, the wireless connection between the control system 30 and the external power source (e.g., an adjacent smart device or wireless power-bank), and/or a remotely located server, is terminated.

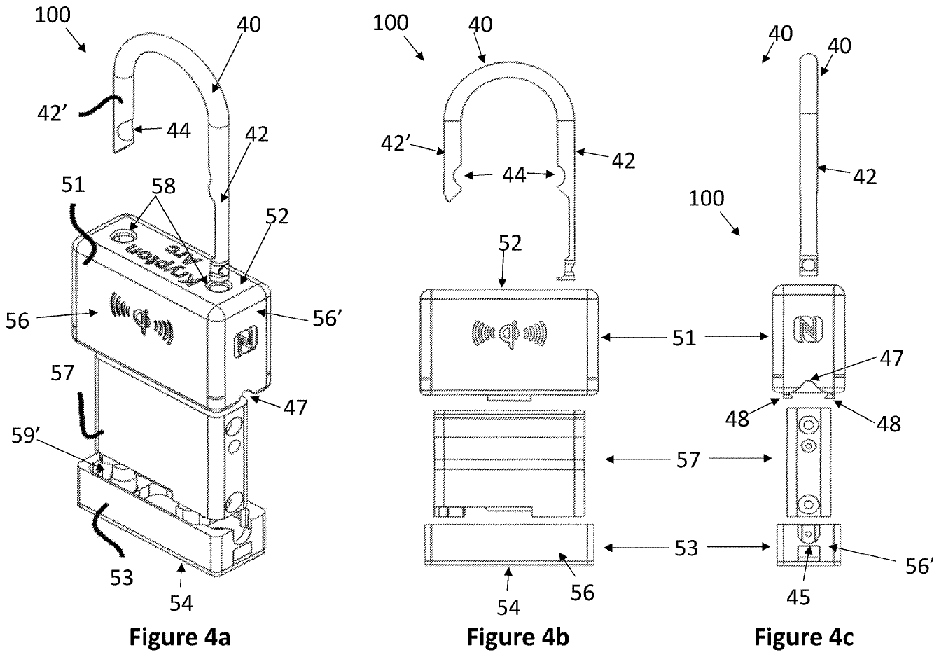

Referring to FIGS. 4 to 7, the outer shell of the base module 50 can include a plurality of sleeves 51,53 that are adapted to couple together around a main controller body 57. The main controller body 57 houses the locking mechanism 10 and the control system 30, and can be configured to interface with one or more of the sleeves 51,53 in order to transfer electrical power from the wireless power receiver 20 into one or more other components of the electronic system 100.

An upper sleeve 51 of the sleeves 51,53 comprises the upper surface 52 of the base module 50, having the one or more apertures 58 through which the arms 42 of the shackle 40 are able to be received in use. The one or more of the side walls 56,56′ of the upper sleeve 51 are formed to surround a hollow interior region 59 that corresponds in cross-sectional profile and depth to receive at least an upper portion of the main controller body 57 therein. Two or more cavities 21,21′ are formed along one or more of the side walls 56,56′ of the upper sleeve 51. The cavities 21,21′ are adapted to act as pockets for retaining and supporting the wireless power receivers 20 proximal to the outer portion of the side walls 56,56′. As would be appreciated by a person skilled in the art, in some variations the wireless power receivers can also, or alternatively, be retained and supported in cavities that are formed proximal to one or both of the upper surface and/or lower surface of the base module. The cavities 21′ in the narrower side walls 56′ can contain wireless power receivers 20′ configured to use a different charging standard from the wireless power receivers 20 retained and supported by the cavities 21 in the wider side walls 56. For example, in one variation the cavities 21′ in the narrower side walls 56′ can comprise wireless power receivers 20′ utilising NFC charging standards, whilst the cavities 21 in the wider side walls 56 can comprise wireless power receivers 20 utilising Qi charging standards. In some variations, NFC modules can also be utilised for communication external of the base module 50. Outer portions of the side walls 56,56′ of the upper sleeve 51 are formed from a non-magnetic material that enables the wireless transfer of electrical power to occur therethrough. Similarly, the thickness of the side walls 56,56′ is formed to be sufficient for providing a tamper proof protective shell without preventing the transfer of electrical power through the side walls 56,56′. The upper sleeve 51 also comprises a plurality of cavities 21″ that are adapted to receive and support an antenna 24 that facilitates communication of the control system 30 with external smart devices that are held located adjacent the electronic system 100 and/or the remotely located servers. The cavities 21″ can be fitted with one or more indicator lights (e.g., including LEDs), not shown, that can provide a user interface that indicates to a user a status of the electronic system 100, for example the locked or unlocked configuration of the locking mechanism 10.

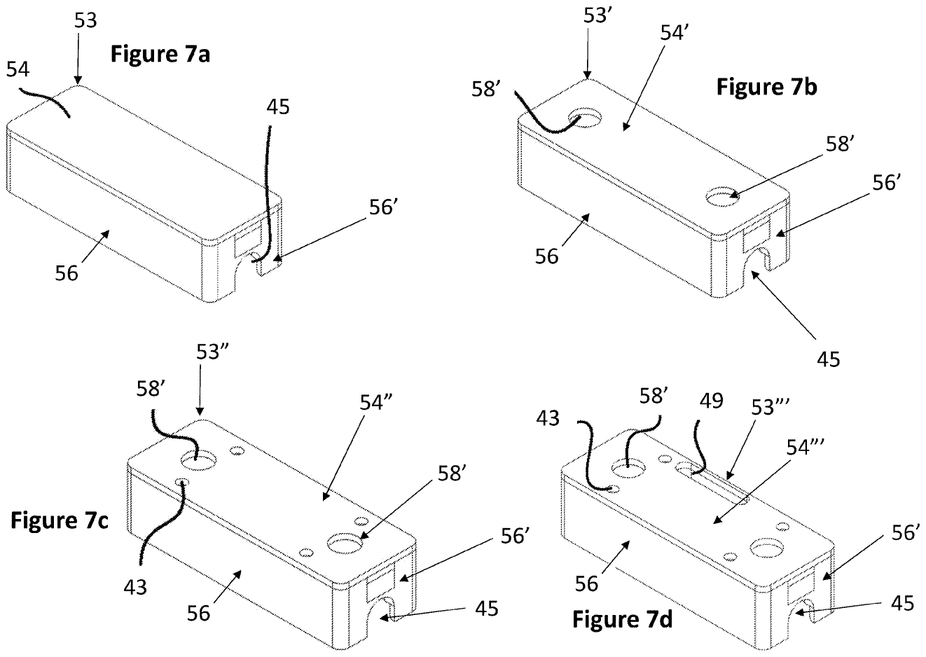

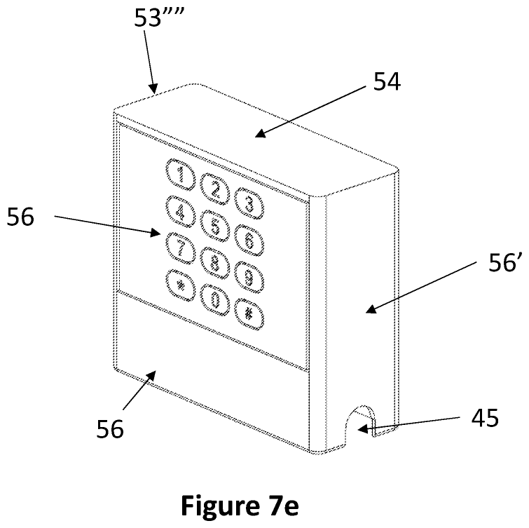

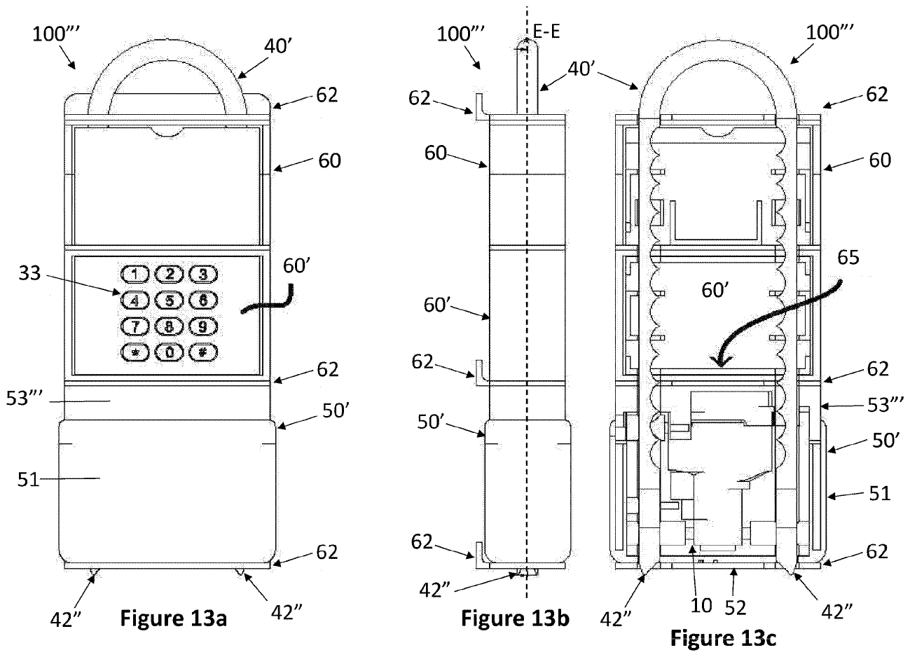

The lower sleeve 53 comprises the lower surface 54 of the base module 50 and is arranged to at least partially locate inside, and couple with, the upper sleeve 51, so as to provide a lid-like covering over a lower portion of the main controller body 57. The side walls 56,56′ of the lower sleeve 53 define a smaller rectangular cross-sectional shape than the side walls 56,56′ of the upper sleeve 51, allowing for the side walls 56,56′ of the lower sleeve 53 to be slidingly received, at least in part, within the upper sleeve 51. The side walls 56,56′ of the lower sleeve 53 are formed to surround a hollow interior region 59′ that corresponds in cross-sectional profile and depth to receive at least the lower portion of the main controller body 57 therein. The lower surface 54 can be a planar surface that extends across and covers a base of the base module 50. In some variations of the base module 50′, such as when the U-shaped shackle 40′ comprises a pair of elongate arms 42″ of substantially equal length, the lower surface 54′ can also comprise one or more apertures 58′, and preferably a pair of apertures 58′, with each of the apertures 58′ of the lower surface 54′ being aligned vertically with a corresponding one of the one or more apertures 58 through the upper surface 52 (e.g. as shown in FIGS. 7b to 7d). The apertures 58′ through the lower surface 54′ may be also adapted to have a diameter that corresponds to the diameter of a respective one of the arms 42,42′ of the shackle 40, thereby allowing the distal ends of the arms 42,42′ to pass through, and protrude outside of, the base module 50′. In further variations, where the base module 50 is integrated with extension modules 60, the lower surface 54′″ of the lower sleeve 53′″ can further comprise one or more outlets 49 via which a variety of electronic-connectors, such as wires, cables or connector busses 65, can be fed out from the base module 50′ to connect with the adjacent extension module/s 60 (e.g., as shown in FIG. 7d or FIG. 13c). Alternatively or in addition, in some variations, the lower surface 54″ of the lower sleeve 53″ can further comprise screw holes 43 that can be used to couple the base module 50′ to the adjacent extension module/s 60 using one or more screws that are passed through the screw holes 43 (e.g., as shown in FIGS. 7c and 7d). In a further variation, the lower sleeve 53″ of the extension modules 60 can be configured to comprise one or more of a speaker, a microphone, a cellular and/or wireless connection module, a keypad or alternative user interface module, a GPS and/or location tracking module, an alarm module, a module capable of providing light, a line-of-sight communication module (e.g. IR-DA), a camera module, a doorbell module, a key vault module, and/or a safe vault module. For example, with reference to FIG. 7e, the lower sleeve 53″″ can be configured to comprise a user interface in the form of a numeric keypad 75 that is integrated into one of the side walls 56 of the lower sleeve 53″″. In some further variations, the lower sleeve 53″ of the extension modules 60 can be configured to comprise one or more of a battery module, a solar panel module, an AC powered module, which can provide electrical power from the extension modules 60 to the base module 50. This may allow a user to activate the electronic system 100 in situations where the user does not have a separate mobile external power source, or their external power source (which may, for example, include a smart phone) does not have sufficient electrical power for a wireless transmission.

In forms where the base module 50 is part of an electronic system 100 used for security (e.g. the padlock), the lower sleeve 53, the main controller body 57, and the shackle 40 can be formed substantially from strong materials, such as metal (e.g. steel). In other applications of the electronic system 100, for example as a controller module or as a modular doorbell system, the lower sleeve 53, the main controller body 57, and the shackle 40 can be formed substantially from other materials including, but not limited to, fibre reinforced polymers.

In use, the base module 50 is assembled by inserting the main controller body 57 within the hollow interior region 59′, and then fixing the main controller body 57 to the lower sleeve 53 using one or more screws that are inserted via at least one opening 45 through one or more of the side walls 56,56′. The upper sleeve 51 can then be coupled via a snap-engagement of a plurality of tabs 48 that project away from a lower rim of the side walls 56,56′ of the upper sleeve 51 and mate with a corresponding plurality of grooved ridges, not shown, provided intermediate the upper rim of the side walls 56,56′ and the lower surface 54 of the lower sleeve 53. The opening 45 can be covered by a removable cap 46 that is slidable into an indentation 47 provided at the lower rim of the side walls 56,56′.

The external power source may for example include a smartphone, wireless power-bank, or other smart device having an on-board power supply, user interface and/or a cellular and/or wireless data connection, and/or any transmitting device capable of wirelessly transmitting electrical power to temporarily provide sufficient electrical charge to the electronic system 100 such that it can be operate and complete the desired configuration changes and/or actions. For example, the configuration changes and/or actions may include, but are not limited to, powering on, powering off restarting, resetting, managing user and system access, operating the locking mechanism, communicating with and/or controlling the one or more extension modules 60, taking no action etc. When the control system 30 detects a wireless input of electrical power has been received by the wireless power receiver 20, the activated control system 30 can communicate with the processor of the external power source, via Bluetooth or Wi-Fi or other known wireless communication protocols, in real-time in order to determine if any configuration changes or actions are required to be performed by the electronic system 100. The external power source can be configured to autonomously, in response, communicate a specific pre-determined code and or program of instructions to the control system 30 which can then be compared against programmed criteria stored by the control system 30. In variations where the external power source is a smart device, the user of the smart device can utilise a corresponding control application on the smart device to manually control configuration changes and/or actions that are sent to the electronic system 100. In circumstances where the control system 30 fails to receive a pre-determined code from the external power source, the control system 30 can control the configuration of the electronic system 100 to remain unchanged. For example, when activated by the wireless transfer of electrical power, the processor of the external power source is able to direct the control system 30 to configure the locking mechanism 10 to alternate between locked and unlocked configurations.

In a variation, the external power source can enable a remotely located user to control configuration changes and/or actions of the electronic system 100, for example locking or unlocking the locking mechanism 10. The external power source can also be configured to send notifications to and/or receive notifications from remotely located control system, which in response can autonomously or manually control the configuration changes and/or actions of the electronic system 100 whilst the electronic system 100 remains powered to operate.

In some variations, one of the extension modules 60 that are integrated with the electronic system 100 can comprise a button or keypad which can be used to unlock and transmit electrical power to the base module 50 to initiate operation of the control system/ 30. The control system 30 can then communicate wirelessly to an external smart device or remotely located server to determine if any configuration changes and/or actions should be performed by the electronic system 100.

In some variations, the electronic system 100 can include an alarm system, which is configured to activate an audible alarm when an unauthorized user or device attempts to modify the configuration of the electronic system 100. When the alarm is activated, a data entry of the time, date and device can be recorded by the processor of the electronic system 100. In some variations, a notification can also be sent to a remotely located user and/or server.

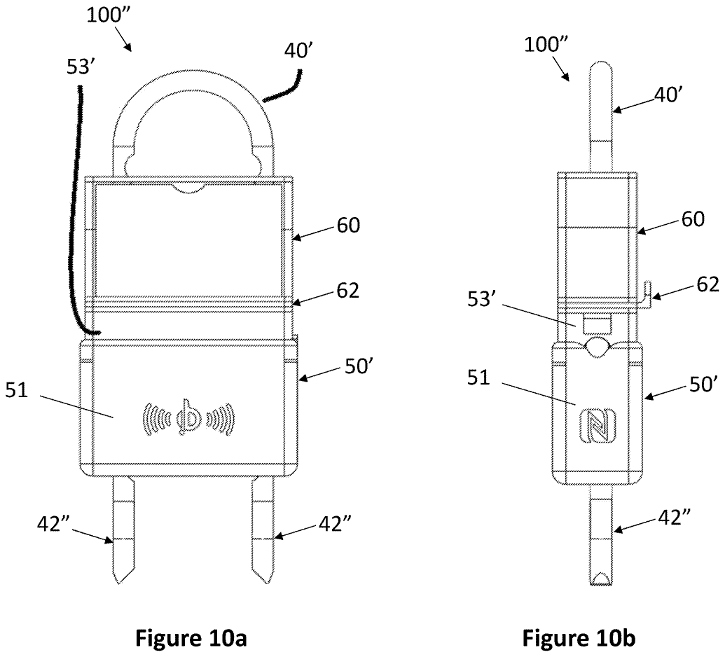

Referring now to FIGS. 10 to 13, the modular electronic system 100 can comprise the one or more modules 60, in addition to the base module 50. The extension module/s 60 can be stand-alone or configured to integrate and communicate with the base module 50. For example, the base module 50 can be configured to send electrical power to the extension module 60, or to receive additional electrical power from the extension module 60 once activated by the input of electrical power via a wireless power receiver 20. In some variations, the control system 30 of the base module 50 can communicate with and/or control operation of the extension module 60 once activated by the input of electrical power via a wireless power receiver 20 via wires, cables or connector busses 65 that are fed through one or more outlets 49 through the lower surface 54′″ of the lower sleeve 53′″ and connected to the adjacent extension module/s 60 (e.g., as shown in FIG. 13). In some variations, once activated by the input of electrical power via a wireless power receiver 20, the control system 30 of the base module 50 can be controlled via communication received from one or more of the extension modules 60. In some variations, the base module 50 and extension modules 60 can operate independently of one another.

The base module 50′ of the electronic system 100″ can be secured to the shackle 40′ by engagement of the locking bars 12 of the locking mechanism 10 with the grooves 44 that are provided along the inwardly facing sides of the pair of elongate arms 42″. The extension modules 60 can each comprise the one or more through holes 68, corresponding to the number of arms 42″, with the through holes 68 extending through the extension modules 60 from one side to an opposing side, and being adapted to receive the arms 42″ therethrough. Once the desired extension modules 60 have been threaded onto the arms 42″ of the shackle 41, the position of the lower surface 54″ of the base module 50′ relative to the top 41 of the U-shaped curve of the shackle 40′ can be determined and adjusted such that the one or more extension modules 60 are secured in position, and abut, between the base module 50′ and the top 41 of the U-shaped curve of the shackle 40′. In some variations, adjacent modules 50′,60 of the electronic system 100″ can be secured together using the screw holes 43 provided on the lower surface 54″ of the lower sleeve 53″ in order to prevent movement of the extension modules 60 along the arms 42″ of the shackle 40′ (e.g., as shown in FIGS. 10 to 12).

Examples of extension modules 60 that can be integrated with the electronic system 100 include, but are not limited to a speaker, a microphone, a cellular and/or wireless connection module, a keypad or alternative user interface module, a GPS and/or location tracking module, an alarm module, a module capable of providing light, a line-of-sight communication module (e.g. IR-DA), a camera module, a battery module, a solar panel module, an AC powered module, a doorbell module, a key vault module, and/or a safe vault module.

In some variations, a right angle bracket 62 can be inserted between adjacent modules 50,60, and can be used, for example, to mount the electronic system 100″ to a wall. The right angle bracket 62 can comprise one or more through holes 68 to allow for the wires, cables or connector busses 65 to be fed therethrough. The right angle bracket 62 can also comprise screw holes 43 so as to allow for adjacent modules 50,60 to be fastened together through the right angle bracket 62.

In some variations, the electronic system 100 can comprise a waterproof cover to protect the system 100 against ingress of water, dust or other contaminants. Exposed outlets 49, screw holes 43, and apertures 58 can also be covered by protective caps, if needed, to protect against ingress of water, dust or other contaminants.

For example, referring to FIGS. 10 to 12, the electronic system 100″ can comprise an additional extension module 60 that is configured to act as a key vault. The key vault extension module 60 is slidingly threaded onto the arms 42″ of the shackle 40′, followed by a right angle bracket 62, followed by the base module 50′. The base module 50 can be inverted such that the arms 42″ of the shackle 40′ enter the base module 50′ through the apertures 58′ in the lower surface 54″, pass through the base module 50′, and exit the base module 50′ through the apertures 58 in the upper surface 52. The lower surface 54″ of the base module 50′ can be fastened to the key vault extension module 60 using a plurality of screws that are passed through the aligned screw holes 43 of the base module 50′, right angle bracket 62, and key vault extension module 60. A door 35 of the key vault extension module 60 comprises a plurality of flanges 36 that extend across the interior of the chamber defined within the key vault extension module 60, with the flanges 36 each comprising an aperture 68 that is adapted to receive an arm 42″ of the shackle 40′. Thus, the door 35 of the key vault extension module 60 remains closed, and in a locked configuration, by engagement of the shackle 40′ with the flanges 36 until the arms 42″ of the shackle 40′ are removed from therein.

In a further example, referring to FIGS. 13a to 13c, in addition to the base module 50′ the electronic system 100′″ comprises a plurality of the extension modules 60,60′. The electronic system 100′″ comprises a key vault extension module 60 in addition to a keypad user interface extension module 60′. The keypad user interface extension module 60′ can be located between the key vault extension module 60 and the base module 50′ along the length of the arms 42″ of the shackle 40′. The keypad user interface extension module 60′ can enable ad-hoc users with a wireless power transmitter to unlock the shackle 40′ in order to access secured items inside of the key vault extension module 60. Once activated by the wireless power transmitter, the control system 30 can transfer electrical power to the keypad user interface extension module 60′ via the connector bus 65 to activate the keypad user interface extension module 60′. If a user correctly enters the pre-defined passcode using the keypad 33 of the keypad user interface extension module 60′, the keypad user interface extension module 60′ communicates to the control system 30 to control the locking mechanism 10 to move to an unlocked configuration, thereby allowing the shackle 40′ to be removed from the modules 50′,60,60′ in order to release the flanges 36 of the key vault extension module 60 and open the door 35. If an incorrect passcode is entered, the control system 30 maintains the mechanism 10 in a locked configuration. In some variations, when it is desired to lock the door 35 of the key vault extension module 60, a user can return the modules 50′,60,60′ into their desired arrangement along the shackle 40′, then activate the control system 30 of the base module 50′ using the wireless power transmitter, re-enter the correct passcode into the keypad 33 of the key vault extension module 60, and return the locking mechanism 10 to a locked configuration, thereby locking the system 100′″.

In another variation, the electronic system 100 can comprise two or more base modules 50 that are integrated together so as to be controlled by the control system 30 to simultaneously move between the locked and unlocked configuration. Additional base modules 50 may improve the security of the system 100.

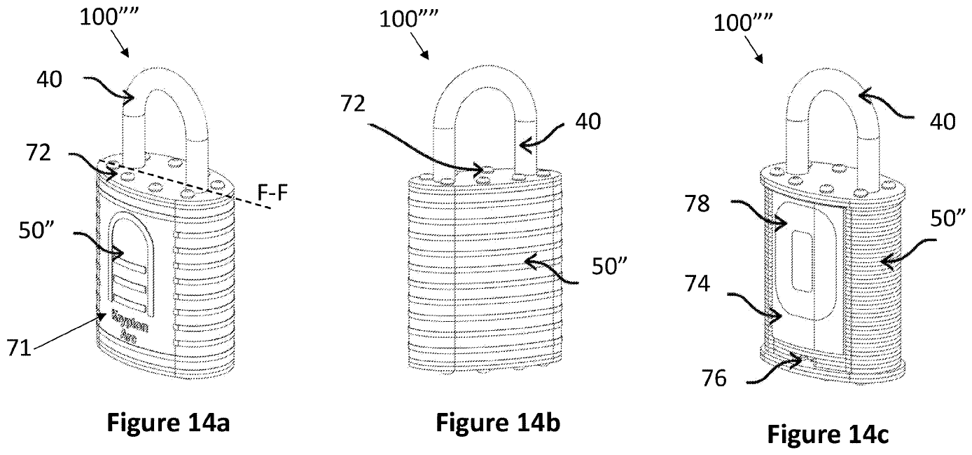

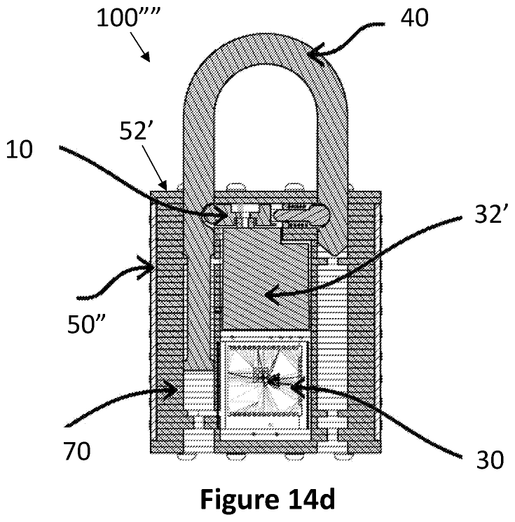

Referring to FIGS. 14A to 14D, in a further variation the tamper proof shell of the electronic system 100″″ can comprise a single-piece outer casing base module 50″ that comprises of magnetically permeable (e.g., plastic) outer layer that covers an under layer of laminated metal layers 70, a wireless power coil and a wireless communication antenna 78. The base module 50″ houses the control system 30 and locking mechanism 10 therein. The upper surface 52′ of the base module 50″ is secured to the main body of the base module 50″ via a plurality of rivets 72, or alternative fasteners. A ferrite sheet pad 74 is arranged along a side wall of the base module 50″ The ferrite sheet pad 74 suppresses the effect of the metal of the laminated metal layers 70 and acts to improve the communication of the wireless power receiver 20 when utilising the near field wireless technologies, such as Qi or NFC charging standards. A wire and antenna channel 76 can be adapted towards an in-use lower end of the base module 50″, whilst a wireless power coil cover and wireless communication antenna 78 can be provided over the ferrite sheet pad 74 along the side wall of the base module 50″. The ferrite sheet pad 74, wire and antenna channel 76 and wireless power coil cover and wireless communication antenna 78 are all covered by a magnetically permeable (e.g., plastic) outer casing panel 71 such that they are contained within the outer casing of the base module 50″.

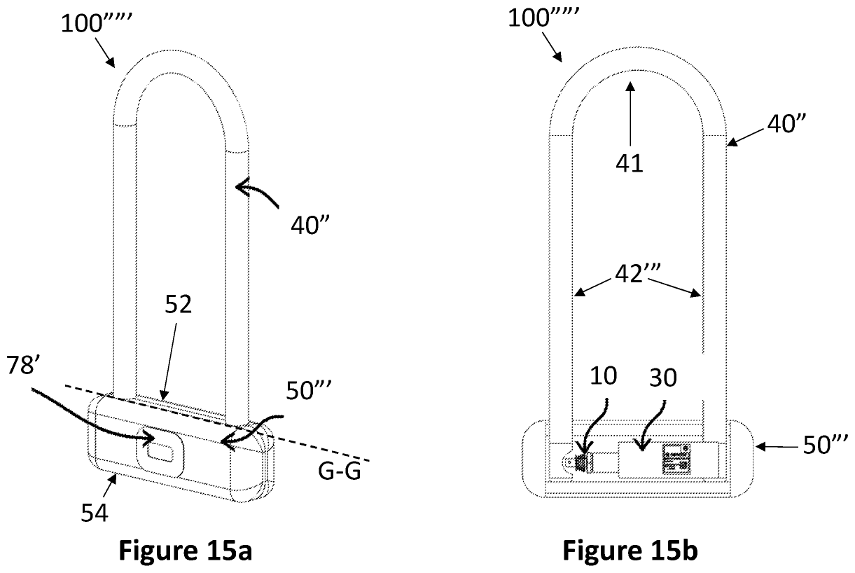

Referring to FIGS. 15A and 15B, in a further variation the electronic system 100′″″ can be configured as a padlock suitable for securing bikes, or similar items. The electronic system 100′″″ comprises a U-shaped shackle 40″ having a pair of elongate arms 42′″ of substantially equal length. The control system 30 can be programmed to allow for the distance between the top 41 of the U-shaped curve of the shackle 40″ to be adjusted relative to the upper surface 52 of the base module 50′″, whilst restricting against the removal of the entirety of the arms 42′″ of the shackle 40″ outside of the base module 50′″. The tamper proof casing of the base module 50′″ has opposing planar upper 52 and lower surfaces 54 that are arranged to extend substantially parallel to one another, with two pairs of opposing sidewalls that extend between the upper 52 and lower surfaces 54. In a variation, as would be appreciated by a person skilled in the art, the body of the base module can be formed to define a variety of prismatic or other three-dimensional geometrical shapes. The locking mechanism 10 is controlled by activation of the control system 30 when electrical power is transferred wirelessly to the electronic system 100′″″ via the wireless power coil cover and wireless communication antenna 78′.

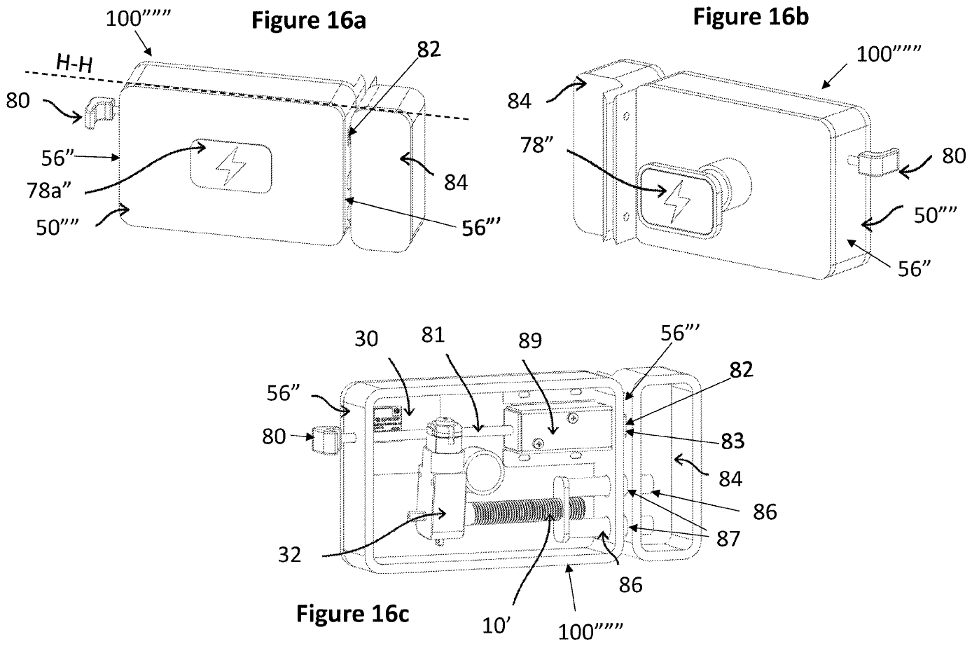

Referring to FIGS. 16A, 16B and 16C, in a further variation the electronic system 100″″″ can be configured as a battery-less smart door lock mechanism. The battery-less smart door lock system is mountable on an inner facing side of a door or gateway or similar surface. As would be appreciated by a person skilled in the art, additional variations may exist where the electronic system can be configured for use as a window lock, a gate lock, a cabinet lock, a mono-block lock, a container lock, a musical instrument case lock, a suitcase lock, a steering wheel lock etc. The electronic system 100″″″ comprises a shackle handle 80 that protrudes from a first side wall 56″ of a tamper proof casing 50″″ of the lock. The shackle handle 80 is connected to a latch bolt 82 that protrudes from an opposing second sidewall 56′″ of the tamper proof casing 50″″ via a shackle body 81 whereby in use when the shackle handle 80 is pulled away from the adjacent side wall 56″, the latch bolt 82 is pulled a corresponding distance inwards towards the opposing second sidewall 56′″. When in a locked configuration, the latch bolt 82 is adapted to extend into a recess 83 provided in the corresponding strike 84 thereby preventing the door lock mechanism from opening. When moved into an unlocked configuration, when the shackle handle 80 has been pulled such that the latch bolt 82 does not extend into the recess 83 of the strike 84, the door lock mechanism is not prevented by the latch bolt 82 from being opened. The latch bolt 82 can be opened by a user from the inside of the door or gate by manually pulling the shackle handle 80, or alternatively, by wirelessly transmitting power to the electronic system 100″″″ via the interior facing wireless power coil and wireless communication antenna 78a″ which is adapted on the rearward facing surface of the casing 50″″. A further externally facing wireless power coil and wireless communication antenna 78″ is also provided on the front face of the casing 50″″, and can be elevated away from the front face of the casing 50″″ so as to project through to the outer side of a door or gateway or similar surface. When activated by the wireless transmission of electrical power, the control system 30 can actuate a linear motion of a solenoid 89 to electronically move the latch bolt 82 between the locked and unlocked configurations.

The electronic system 100″″″ further comprises a deadbolt lock mechanism 10′ that functions in a manner similar to that of the lock mechanism 10 described above. The deadbolt lock mechanism comprises one or more bolts 86 which are each adapted to protrude from the second sidewall 56′″ of the tamper proof casing 50″″ into a respective correspondingly shaped and sized bolt hole 87 provided in the strike 84. When the deadbolt lock mechanism is in a locked configuration, the one or more bolts 86 are adapted to extend into the bolt holes 87 of the strike 84 thereby preventing the door lock mechanism from opening, even if the latch bolt 82 has been position in an unlocked configuration. When the deadbolt lock mechanism is in an unlocked configuration, the one or more bolts 86 are retracted by the deadbolt locking mechanism 10′ inwards towards the casing 50″″ such that they do not extend into, or engage with, the bolt holes 87 of the strike 84, whereby the one or more bolts 86 do not prevent the door lock mechanism from being opened. The deadbolt locking mechanism 10′ is operated to change between a locked and unlocked configuration by the control system 30, when the control system 30 is activated by a wireless transfer of electrical power thereto via the wireless power coil and wireless communication antenna 78″. The control system 30 controls the rotation of the motor 32 which drives the locking mechanism 10′ to retract the one or more bolts 86 towards the unlocked configuration or extend them towards the locked configuration.

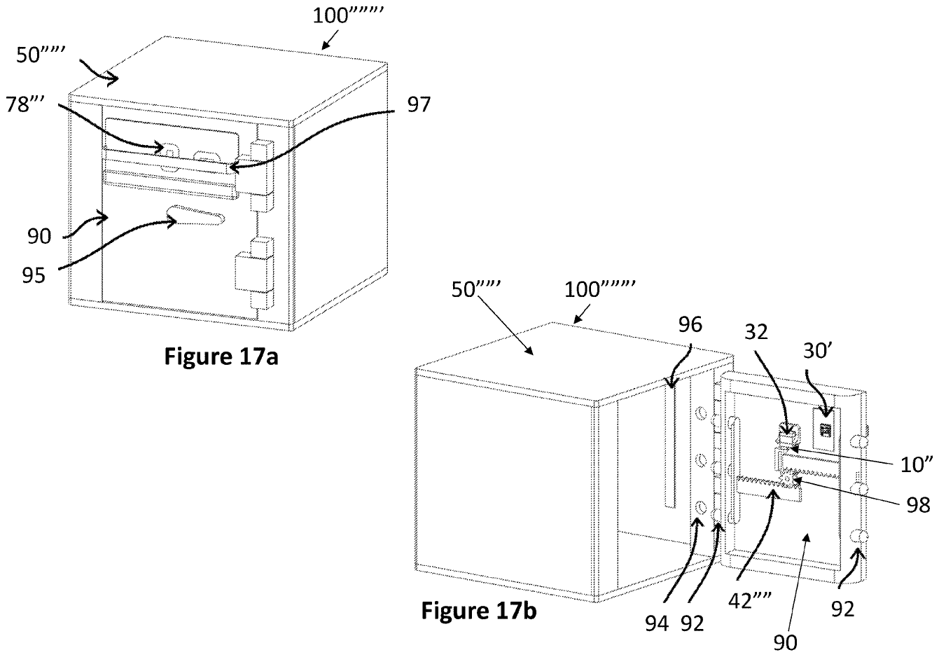

Referring to FIGS. 17A and 17B, in a further variation the electronic system 100′″″″ can be configured as a battery-less smart safe or security box lock mechanism. As would be appreciated by one skilled in the art, the control system 30′ and lock mechanism 10″ can be adapted and integrated into the tamper proof casing 50′″″. For example, the control system 30′ and lock mechanism 10″ can be integrated with the door 90 of the safe or security box lock mechanism. The electronic system 100′″″″ comprises one or more locking bolts 92, with each locking bolt 92 extending parallel to an inwardly facing planar surface of the door 90. Each locking bolt 92 is driven by one or more gears 98 to move laterally along the planar surface between a locked position and an unlocked position. In the locked position, the locking bolts 92 protrude from one or more side walls of the door 90 into a respective corresponding bolt hole 94 thereby preventing the door 90 from being moved into an open position. In the unlocked position, the locking bolts 92 are retracted by the gear/s 98 towards one another parallel to a plane of the door 90 so as to be withdrawn from engagement with the respective corresponding bolt holes 94 thereby allowing the door 90 to be freely moved between a closed position and an open position. The locking bolts 92 can be spaced from one another along a planar connecting bar, with the connecting bar being fixed to a shackle arm 42″″ which comprises a plurality of gear teeth that extend in a linear pattern along a length of one or more edges of the shackle arm 42″″. The gear teeth of the shackle arm 42″″ are adapted to engage with the teeth of the one or more driving gears 98, thereby moving the locking bolts 92 inwards or outwards of the one or more side walls of the door 90.

The control system 30′ and motor 32 can be configured, when activated by a wireless transfer of electrical power thereto via the wireless power coil and wireless communication antenna 78′″, to activate the lock mechanism 10″ which locks or unlocks a rotatable handle 95 that protrudes from the front surface of the door 90. The handle 95 is coupled on an inwardly facing surface of the door 90 to the one or more gears 98, with the gears 98 being configured to drive the shackle arms 42″″ and one or more locking bolts 92 between a locked configuration and an unlocked configuration. In use, after the control system 30′ has been activated by a wireless transfer of electrical power, the control system 30′ is able to wirelessly communicate with an external or remotely located control system, such as a smartphone application or a platform hosted on the internet in order to receive instructions as to whether the lock mechanism 10″, via the motor 32, should be moved to lock or unlock the handle 95. Once unlocked, a user can manually rotate the handle 95 in order to drive the one or more gears 98 in order to move the shackle arms 42″″ laterally along the inner planar surface of the door 90, whereby the locking bolts 92 are withdrawn from engagement with the respective corresponding bolt holes 94 provided in the tamper proof casing 50′″″. Once the locking bolts 92 have been withdrawn, the door 90 is then allowed to be freely moved between a closed position and an open position.

The electrical power received by wireless power coil and wireless communication antenna 78′″ can also be used to power accessories of the electronic system 100′″″″, for example a light 96 that is contained within the safe or security box lock mechanism. In addition, the outer surface of the door 90 can comprise a holder 97 for a wireless power transmitter, for example a smartphone or a power-bank, which may help with maintaining a wireless supply of electrical power to the electronic system 100′″″″ whilst locking or unlocking the locking mechanism 10″.

Variations and modifications may be made to the parts previously described without departing from the spirit or ambit of the disclosure. As would further be appreciated by a person skilled in the art, a wide variety of applications may exist where an electronic system is activated when powered by an input of electrical power from a power source that is located externally of the electronic system. Such systems may include, but are not limited to a doorbell system or home automation system.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The presence of “/” in a FIG. or text herein is understood to mean “and/or” unless otherwise indicated, i.e., “A/B” is understood to mean “A” or “B” or “A and B”. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 50%, 60%, 70%, 80%, or 90%, for instance, 92.5%, 95%, 97.5%, 99%, or 100%.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A locking system having a body comprising a control system and an electronic power receiver, the electronic power receiver being activated to operate the control system by a wireless transmission of electrical power from an external power source, wherein the electronic power receiver ultilizes the Qi charging standard.

2. The locking system of claim 1, wherein the body comprises a first surface and a second surface, and opposing sidewalls that extend therebetween, the first surface comprising one or more apertures therethrough, and wherein the locking system further comprises a shackle, the body being adapted to receive at least a portion of one or more arms of the shackle therein through the one or more apertures of the first surface.

3. The locking system of claim 2, wherein the one or more apertures extend through the body and the second surface on an opposing side of the body to the first surface, the one or more apertures through the second surface being aligned with the one or more apertures through the first surface.

4-6. (canceled)

7. The locking system of claim 3, wherein the one or more arms of the shackle extend through, and protrude beyond, the body.

8-9. (canceled)

10. The locking system of claim 2, further comprising a locking mechanism that is at least partially contained within the body, the locking mechanism being configurable by the control system between a locked configuration, in which the locking mechanism engages with the portion of the one or more arms of the shackle received within the body, in use, so as to prevent relative movement of the shackle relative to the body, and an unlocked configuration in which the shackle is allowed to move relative to the body.

11. The locking system of claim 10, wherein least one of the following is true when the locking mechanism is in the unlocked configuration:
(i) the one or more arms of the shackle can be removed from the body; and
(ii) the locking mechanism allows the shackle to move relative to the body and prevents removal of the entirety of shackle outside of the body.

12. (canceled)

13. The locking system of claim 10, wherein the locking mechanism comprises one or more locking bars, each of the one or more locking bars being arranged to project towards, and engage with, a groove provided in an adjacent one of the arms of the shackle when in the locked configuration, and each of the one or more locking bars being arranged to retract away from the adjacent one of the arms of the shackle by a movement of the shackle relative to the one or more locking bars when in the unlocked configuration.

14. The locking system of claim 13, wherein, in the unlocked configuration, the one or more locking bars are configured to resiliently retract.

15. The locking system of claim 13, wherein the locking mechanism further comprises a rotatable drum that is controlled to rotate by the control system,
the drum having a locking wall that, when in the locked configuration, is controlled by the control system to be rotated so as to locate adjacent to a first end of the one or more locking bars so as to prevent a retraction of the opposing second end of the one or more locking bars from the groove, and
the drum having a hole provided in a portion thereof, the hole having a depth sufficient that, when in the unlocked configuration, the drum is controlled by the control system to be rotated such that the hole locates adjacent to, and is adapted to receive therein, the first end of the one or more locking bars therein so as to allow the one or more locking bars to slide laterally toward the drum such that the opposing second end of the one or more locking bars is retracted from the groove.

16-21. (canceled)

22. The electronic locking system of claim 1, wherein the electronic power receiver does not store electrical power and/or does not receive electrical power from a battery and/or a surge capacitor except via the wireless transmission.

23. The locking system of claim 1, wherein the control system, when activated to operate, can communicate with and/or be controlled by the external power source and/or a remotely located server to implement one or more configuration changes and/or actions.

24-26. (canceled)

27. The locking system of claim 1, further comprises an extension module, the extension module being adapted to be removably coupled to, or secured in adjacency to, the body.

28. The locking system of claim 27, wherein the extension module has a cross-sectional shape that substantially conforms to a cross-sectional shape of the body.

29. The locking system of claim 27, wherein the body comprises a first surface, a second surface, and opposing sidewalls extending therebetween, the first surface comprises one or more apertures therethrough, and wherein the extension module comprises a first and a second surface, and opposing sidewalls that extend therebetween, the first surface comprising one or more apertures that extend through the extension module and the second surface on an opposing side of the extension module, the one or more apertures being arranged to align with, and extend collinearly with an axis through the centre of, the one or more apertures through the first surface of the body, and wherein the one or more apertures through the extension module are adapted to receive the one or more arms of the shackle therethrough.

30-31. (canceled)

32. The locking system of claim 29, wherein a relative position of the extension module along the one or more arms of the shackle can be fixed by a fixed engagement of the body with the shackle.

33. The locking system of claim 27, wherein the extension module derives electrical power from the body or provides electrical power to the body when the electronic power receiver has been activated in use.

34. The locking system of an claim 27, wherein the control system, when activated to operate, can communicate with and/or control or be controlled by the extension module to implement one or more configuration changes and/or actions.

35. The locking system of claim 27, wherein the extension module is configured to communicate with and/or control or be controlled by additional extension modules to implement one or more configuration changes and/or actions.

36. The locking system of claim 27, wherein the extension module is configured to include one or more of a speaker, a microphone, a cellular and/or wireless connection module, a keypad or alternative user interface module, a GPS and/or location tracking module, an alarm module, a module capable of providing light, a line-of-sight communication module, a camera module, a battery module, a solar panel module, an AC powered module, a doorbell module, a key vault module, and/or a safe vault module.

37. (canceled)

38. The locking system of claim 1, wherein the locking system is, or is integrated with, a bicycle lock, a security door, a gate, a safe, a storage unit, a window lock, a suitcase lock, a motor vehicle lock, a cabinet lock, a mono-block lock, a container lock, a musical instrument case lock, and/or a steering wheel lock.

39-41. (canceled)
